(19) United States
(12) Patent Application Publication
(10) Pub. No.: US 2008/0258086 A1
(43) Pub. Date: Oct. 23, 2008

(54) Optical Detector

(76) Inventors: Alan Mathewson, County Cork (IE); John Alderman, County Cork (IE); John Carlton Jackson, County Cork (IE)

Correspondence Address: JACOBSON HOLMAN PLLC, 400 SEVENTH STREET N.W., SUITE 600, WASHINGTON, DC, 20004, US

(21) Appl. No.: 11/661,923

(22) PCT Filed: Aug. 22, 2005
(86) PCT No.: PCT/IE2005/000085

§ 371 Date: Apr. 17, 2008

(30) Foreign Application Priority Data
Sep. 3, 2004 (IE) 2004/0587

(51) Int. Cl. G01N 23/00

(52) U.S. Cl. 250/580

(57) ABSTRACT

An optical detector (1) acts as a modular detection unit. It may for example be mounted on a separate micro-fluidic device (2) for detection of species within a channel (3) of the device (2). The detector (1) has mounting lugs (4) for mounting on the micro-fluidic device (2) for exact registry with the channel (3). A substrate (15) is folded over at a flexible part (25) through 180° and, at the top, supports a vertical emitting laser device (16). The lower branch of the substrate (15) supports an integrated circuit photo-diode array sensor (17) having chip bumps (18). The substrate (15) also supports emitter drive circuitry (26) and detector circuitry (27). The sensor (17) is a silicon integrated circuit, having an array of integrated photo-diodes (17(a)) in a silicon wafer (17(b)). There is a vertical through-hole (17(c)) in the wafer, to act as a guide for incident radiation emitted by the emitter (16) (arrows IR). Because of the single folded-over substrate arrangement the emitter 16 can be particularly easily and accurately aligned with the guide aperture 17(c).

### INTRODUCTION

1. Field of the Invention

The invention relates to optical detection for analysis of samples.

2. Prior Art Discussion

Capillary electrophoresis, or CE, describes a family of techniques used to separate a variety of compounds. These analyses, all driven by an electric field, are performed in narrow tubes and can result in the rapid separation of many hundreds of different compounds. The versatility and number of ways that CE can be used means that almost all molecules, and even whole organisms can be separated.

UV-visible absorption is the most common detection method because it is simple to use and most analytes can be observed with it. It is also a tested method for other chromatographic analyses and can be used quantitatively. When using fused silica capillaries it is possible to use detection wavelengths down to about 200 nm. A window is burnt in the polyamide protecting the capillary and UV light can be shone through and absorbed by passing analytes.

However a problem with the use of CE capillaries for a detection cell comes about because of the very narrow nature of the capillary. This means that the optical beam must be very tightly focused in order to get the best sensitivity. Another problem is that the capillary being thin results in a very short path length for the light. This can lead to CE being somewhat insensitive with some analytes.

Some molecules cannot be observed by UV detectors. They may lack a chromophore and be unsuitable for use with phosphate and borate buffers. This is quite common with carbohydrates and peptides for example. In order to visualize these one must use alternative methods. A common approach is fluorescence. Before analysis the molecules of interest are chemically labelled with a flurophore, and then separation is performed as normal. A light source which excites the flurophore is used as a source of radiation, and as the analytes move past the detection window the flurophores excite and emit radiation at a different wavelength. This can then be detected, once again in a quantitative fashion. This form of detection is useful for analytes present at low concentrations as a powerful flurophore can be chosen, increasing the limit at which they can be detected.

A common method of detection is known as indirect UV detection. This involves using a buffer in the capillary, which actually absorbs the radiation from the lamp along with analytes, which do not absorb UV radiation. As analytes move past the detector the amount of light passing through the capillary increases as UV absorbing buffer is excluded. Indirect UV detection is commonly used for inorganic ions, which do not absorb UV radiation.

The invention is directed towards providing a miniaturised and improved optical detector for analysis applications.

### SUMMARY OF THE INVENTION

According to the invention, there is provided an optical detector comprising:
an emitter for emitting incident radiation for a sample;
a sensor for detecting response radiation from a sample, the sensor comprising a guide for the incident radiation and being mounted on a substrate; and
the emitter is mounted for emitting incident radiation for a sample through the guide.

Thus, the incident radiation is directed particularly accurately for optimum sensing of the response radiation. This is particularly advantageous for applications involving low radiation intensities and physically-constrained situations such as inside the body for medical analysis.

In one embodiment, the sensor substrate allows said incident radiation to pass through it. This allows a particularly compact configuration.

In another embodiment, the detector comprises a filter to pass the response radiation through to the sensor.

In one embodiment, the sensor comprises a plurality of sensor devices, and said devices surround the guide. This allows very effective sensing or response radiation spread over a relatively large cross-sectional area compared with the cross-sectional area of the incident radiation.

In one embodiment, said devices are photo-diodes. In one embodiment, the devices are mounted in an array, and the guide is central within the array.

In one embodiment, the sensor comprises an integrated circuit incorporating the sensor devices. This is a particularly compact and effective arrangement. In one embodiment, the guide passes through the integrated circuit. This allows particularly good accuracy.

In one embodiment, the emitter is located normal to the guide.

In one embodiment, the emitter is a laser device such as a VCSEL.

In one embodiment, the emitter emits radiation with a wavelength of 650 nm.

In one embodiment, the sensor substrate comprises an opening for the incident radiation aligned with the guide.

In one embodiment, the sensor substrate comprises material aligned with the guide which is transparent to the incident radiation.

In one embodiment, said material is opaque to the expected response radiation.

In one embodiment, said filter is transparent to the response radiation and opaque to the incident radiation. This allows excellent integrity in the sensing of radiation.

In another embodiment, the filter comprises a thin film layer on the sensor surface.

In one embodiment, the sensor comprises a plurality of sensor devices, and different filters for at least two devices.

In one embodiment, said filters have different filter characteristics. In this embodiment, said filters may have characteristics for passing fluorescence of different fluorophors.

In one embodiment, the emitter is mounted on a substrate, and said substrate and the sensor substrate are parts of an integral multi-purpose substrate which is folded over between the emitter and the sensor so that the emitter emits incident radiation through the guide.

In one embodiment, he multi-purpose substrate is folded at a flexible part of the substrate.

In one embodiment, the detector further comprises a locating means for locating and mounting the optical detector as a discrete unit on a sample system.

In another aspect, the invention provides an optical detector comprising:
an emitter mounted on a substrate for emitting incident radiation for a sample;
a sensor mounted on the same substrate for detecting response radiation from a sample; and
the substrate being folded over between the emitter and the sensor so that the emitter is located for directing incident radiation at a sample, and the sensor is located to receive response radiation.

In one embodiment, the detector further comprising an emitter drive circuit and a detector sensing circuit mounted on said substrate.

In one embodiment, the substrate is folded over at a flexible part so that it is continuous and curved.

In one embodiment, the substrate supports the emitter so that it is maintained in alignment with a guide in the sensor.

In one embodiment, the substrate is retained in the folded-over configuration by encapsulation.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a diagrammatic perspective view from above of an optical detector of the invention, and

FIG. 2 is an underneath plan view;

FIG. 3 is a general side view, before encapsulation, showing the arrangement of a substrate of the detector;

FIG. 4 is a cross-sectional diagram illustrating the detector in more detail and showing how it is coupled with a microfluidic system to detect a sample in a channel of the microfluidic system;

FIG. 5 is a cross-sectional diagram illustrating an alternative embodiment in a similar manner; and

FIG. 6 is a cross-sectional diagram showing a further optical detector of the invention.

### DESCRIPTION OF THE EMBODIMENTS

Referring to FIGS. 1 to 4 there is shown an optical detector 1 which acts as a modular detection unit. It may be mounted on a separate microfluidic device 2 for detection of species within a channel 3 of the device 2. The detector 1 has mounting lugs 4 for mounting on the microfluidic device 2 for exact registry with the channel 3.

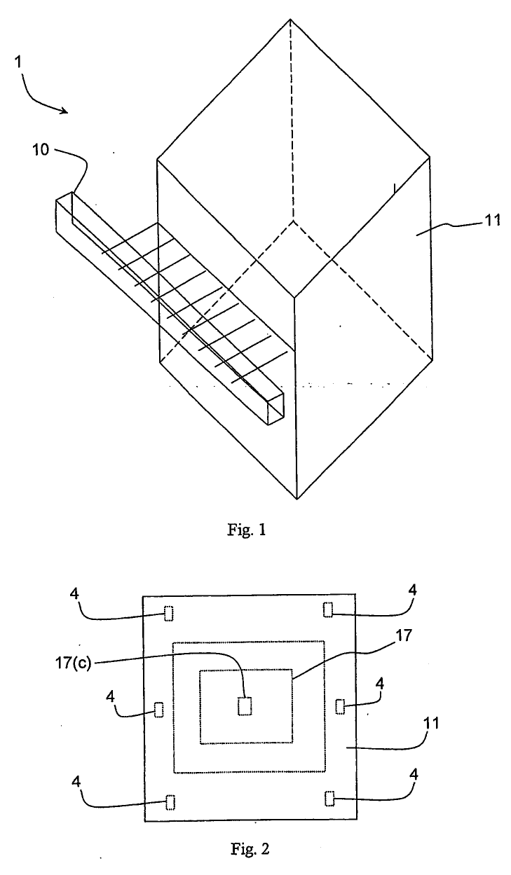

The detector 1 comprises a signal port 10 and this is the only part which connects with an external circuit. The components of the detector 1 are encapsulated in epoxy 11, so that the overall construction is modular and robust. As shown in FIG. 2, the only parts of the detector 1 which protrude are the lugs 4.

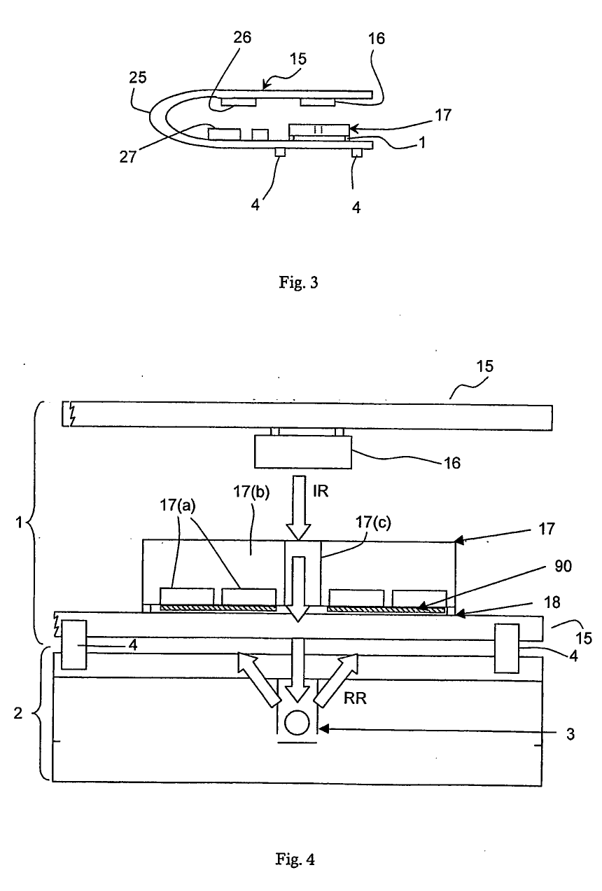

Overall construction of the detector 1 is illustrated in FIG. 3. A substrate 15 is folded over at a flexible part 25 through 180° and, at the top, supports a vertical emitting laser device 16. The lower branch of the substrate 15 supports an integrated circuit photo-diode array sensor 17 having chip bumps 18. The substrate 15 also supports emitter drive circuitry 26 and detector circuitry 27. Thus, the single substrate 15 supports all active components, allowing very simple manufacture. Also, alignment of the emitter 16 and sensor 17 is very simple and accurate. The folding-over and alignment is performed by bringing the light source 16 in approximate alignment with the guide aperture 17(c) in the sensor 17, and ensuring the alignment is sufficient for accurate alignment of light through the guide aperture 17(c). Epoxy is then applied while holding the whole assembly fixed.

Referring to FIG. 4, the sensor 17 is a silicon integrated circuit, having an array of integrated photo-diodes 17(a) in a silicon wafer 17(b). There is a vertical through-hole 17(c) in the wafer, to act as a guide for incident radiation emitted by the emitter 16 (arrows IR). Because of the single folded-over substrate arrangement the emitter 16 can be particularly easily and accurately aligned with the guide aperture 17(c). The substrate 15 is transparent so that the incident radiation IR passes through the guide aperture 17(a) through the wafer and between the diodes 17(a), and through the substrate 15. It then exits the optical detector 1, and when the detector is mounted on the microfluidic device 2 the incident radiation IR impinges on a fluid capillary 3.

Light (“response radiation”, RR) ftom particles in the channel 3 passes through the substrate 15 and a filter 90 and is detected by the array of diodes 17(a) on their undersides. The IR wavelength is 650 nm. The filter 90 is a high pass filter in the form of a thin film coating applied directly to the sensor 17. The cut-off wavelength of the filter 90 is 660 nm, and so it passes the fluorescence RR above this wavelength, while blocking any unwanted reflections or scatter of the (650 nm) incident radiation IR.

The response radiation RR may alternatively be reflected radiation. The filter may alternatively be a discrete glass filter mounted onto the sensor

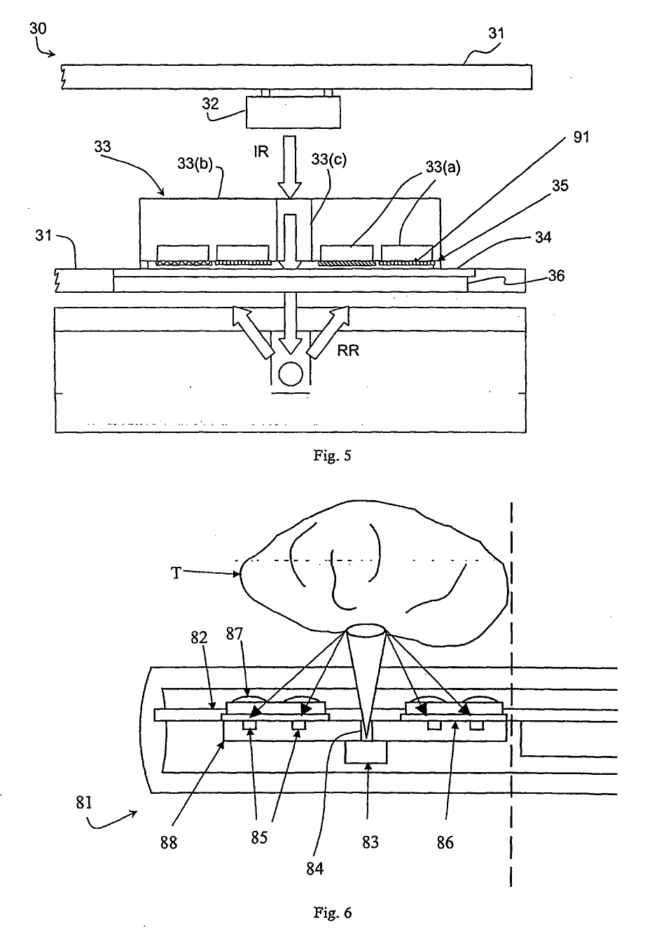

Referring to FIG. 5 a sensor 30 has a substrate 31 supporting a top laser emitter 32 in alignment with a central guide aperture 33(c) of an IC diode array sensor 33. The sensor 33 is mounted by chip bumps 35 onto a filter 34 mounted over an aperture 36 in the substrate 31. Different filters 91 are mounted under different diodes 33(a) to prevent light ftom the emitter from being detected by the diodes (possibly after reflection) and only light of a specific wavelength, i.e. that emitted by the fluorophore will be transmitted through the filter. Thus for each diode 33(a) light of different wavelengths for different fluorophors in the same analyte mixture are detected. The filters 91 are high pass filters in the form of thin film coatings applied directly to the sensor 33, and operate in a manner similar to the filter 90 of the detector 1.

The sensor guide aperture and alignment of the emitter allow particularly accurate excitation of the sample and detection of the fluorescence. This level of accuracy achieves single-photon operation.

Referring to FIG. 7 another optical detector, 80, is shown. The detector 80 has a cylindrical configuration and is 17 mm long and only 2 mm in diameter. A cylindrical housing 81 supports the components inside. These include a ceramic substrate 82, a VCSEL 83 mounted over a guide aperture 84 through an IC diode array sensor having diodes 85. A filter 86 overlies the diodes 85, and collimating lenses 87 overlie the filter 86. In this case the body of the IC of the diodes 85 supports the VCSEL emitter 83.

The sensor 80 may find application implanted inside the body and intended to be used with labelled cancer drugs enabling the monitoring of their uptake by tumours (a tumour T is shown diagrammatically in FIG. 6). It is a full-fluorescence platform and is sensitive to single photons. The VSCEL die 83 is mounted on the back of the sensor die 87. The guide 84 is a hole etched through the sensor die 88, and it allows perfect alignment of the laser light onto the target material relative to the sensors. In this embodiment the filter 86 is mounted onto the sensors and on top of the filter a micro-lens is mounted—ensuring that only collimated light is detected by the diodes 85.

In this embodiment, the VSCEL 83 excitation wavelength is 650 nm. The diodes 85 detect reflected response radiation of greater than 660 nm, the high pass filter cut-off wavelength of the filter 86.

In the detector 81 there is an ASIC to interface with the diodes 85 for photon counting and to read the data. An RF module relays the data to the outside world and an inductive coil is used to power the system.

It will be appreciated that the invention provides a simple, inexpensive, modular, and robust detector for sample analysis applications.

The invention is not limited to the embodiments described but may be varied in construction and detail. For example, where there is a single folded-over substrate this may have a hinge instead of a flexible part or folding over with a curved configuration.

1-28. (canceled)

29. An optical detector comprising:
an emitter for emitting incident radiation for a sample;
a sensor for detecting response radiation from a sample, the sensor comprising a guide for the incident radiation and being mounted on a substrate; and
the emitter is mounted for emitting incident radiation for a sample through the guide.

30. The optical detector as claimed in claim 29, wherein the sensor substrate allows said incident radiation to pass through it.

31. The optical detector as claimed in claim 29, wherein the detector comprises a filter to pass the response radiation through to the sensor.

32. The optical detector as claimed in claim 29, wherein the sensor substrate allows said incident radiation to pass through it, and wherein the detector comprises a filter to pass the response radiation through to the sensor.

33. The optical detector as claimed in claim 29, wherein the sensor comprises a plurality of sensor devices, and said devices surround the guide.

34. The optical detector as claimed in claim 29, wherein the sensor comprises a plurality of sensor devices, and said devices surround the guide; and wherein said devices are photo-diodes.

35. The optical detector as claimed in claim 29, wherein the sensor comprises a plurality of sensor devices, and said devices surround the guide; and wherein the devices are mounted in an array, and the guide is central within the array.

36. The optical detector as claimed in claim 29, wherein the sensor comprises a plurality of sensor devices, and said devices surround the guide; and wherein said devices are photo-diodes; and wherein the sensor comprises an integrated circuit incorporating the sensor devices.

37. The optical detector as claimed in claim 29, wherein the sensor comprises a plurality of sensor devices, and said devices surround the guide; and wherein said devices are photo-diodes; and wherein the sensor comprises an integrated circuit incorporating the sensor devices; and wherein the guide passes through the integrated circuit.

38. The optical detector as claimed in claim 29, wherein the emitter is located normal to the guide.

39. The optical detector as claimed in claim 29, wherein the emitter is a laser device.

40. The optical detector as claimed in claim 29, wherein the emitter is a VCSEL.

41. The optical detector as claimed in claim 29, wherein the emitter emits radiation with a wavelength of 650 nm.

42. The optical detector as claimed in claim 29, wherein the sensor substrate comprises an opening for the incident radiation aligned with the guide.

43. The optical detector as claimed in claim 29, wherein the sensor substrate comprises material aligned with the guide which is transparent to the incident radiation.

44. The optical detector as claimed in claim 29, wherein the sensor substrate comprises material aligned with the guide which is transparent to the incident radiation; and wherein said material is opaque to the expected response radiation.

45. The optical detector as claimed in claim 29, wherein the detector comprises a filter to pass the response radiation through to the sensor; and wherein said filter is transparent to the response radiation and opaque to the incident radiation.

46. The optical detector as claimed in claim 29, wherein the detector comprises a filter to pass the response radiation through to the sensor; and wherein said filter is transparent to the response radiation and opaque to the incident radiation; and wherein the filter comprises a thin film layer on the sensor surface.

47. The optical detector as claimed in claim 29, wherein the detector comprises a filter to pass the response radiation through to the sensor; and wherein said filter is transparent to the response radiation and opaque to the incident radiation; and wherein the sensor comprises a plurality of sensor devices, and different filters for at least two devices.

48. The optical detector as claimed in claim 29, wherein the detector comprises a filter to pass the response radiation through to the sensor; and wherein said filter is transparent to the response radiation and opaque to the incident radiation; and wherein the sensor comprises a plurality of sensor devices, and different filters for at least two devices; and wherein said filters have different filter characteristics.

49. The optical detector as claimed in claim 29, wherein the detector comprises a filter to pass the response radiation through to the sensor; and wherein said filter is transparent to the response radiation and opaque to the incident radiation; and wherein the sensor comprises a plurality of sensor devices, and different filters for at least two devices; and wherein said filters have different filter characteristics; and wherein said filters have characteristics for passing fluorescence of different fluorophors.

50. The optical detector as claimed in claim 29, wherein the emitter is mounted on a substrate, and said substrate and the sensor substrate are parts of an integral multi-purpose substrate which is folded over between the emitter and the sensor so that the emitter emits incident radiation through the guide.

51. The optical detector as claimed in claim 29, wherein the emitter is mounted on a substrate, and said substrate and the sensor substrate are parts of an integral multi-purpose substrate which is folded over between the emitter and the sensor so that the emitter emits incident radiation through the guide; and wherein the multi-purpose substrate is folded at a flexible part of the substrate.

52. The optical detector as claimed in claim 29, further comprising a locating means for locating and mounting the optical detector as a discrete unit on a sample system.

53. An optical detector comprising:
an emitter mounted on a substrate for emitting incident radiation for a sample;
a sensor mounted on the same substrate for detecting response radiation from a sample; and
the substrate being folded over between the emitter and the sensor so that the emitter is located for directing incident radiation at a sample, and the sensor is located to receive response radiation.

54. The optical detector as claimed in claim 53, further comprising an emitter drive circuit and a detector sensing circuit mounted on said substrate.

55. The optical detector as claimed in claim 53, further comprising an emitter drive circuit and a detector sensing circuit mounted on said substrate; and wherein the substrate is folded over at a flexible part so that it is continuous and curved.

56. The optical detector as claimed in claim 53, further comprising an emitter drive circuit and a detector sensing circuit mounted on said substrate; and wherein the substrate supports the emitter so that it is maintained in alignment with a guide in the sensor.

57. The optical detector as claimed in claim 53, wherein the substrate is retained in the folded-over configuration by encapsulation.
